(19) United States
(12) Patent Application Publication
(10) Pub. No.: US 2025/0293332 A1
(43) Pub. Date: Sep. 18, 2025

(54) SYSTEMS AND METHODS FOR REMOVAL, MODIFICATION, AND ADDITION OF COATINGS IN ELECTROACTIVE MATERIALS

(71) Applicant: Li Industries, Inc., Pineville, NC (US)

(72) Inventors: David YOUNG, Sudbury, MA (US); Zheng LI, Charlotte, NC (US); Panni ZHENG, Charlotte, NC (US); Tairan YANG, Indian Land, SC (US)

(21) Appl. No.: 19/226,704

(22) Filed: Jun. 3, 2025

Related U.S. Application Data
(63) Continuation of application No. PCT/US2023/082935, filed on Dec. 7, 2023.
(60) Provisional application No. 63/386,808, filed on Dec. 9, 2022.

(51) Int. Cl. H01M 10/54; C22B 7/00; H01M 4/02; H01M 4/36; H01M 4/525

(52) U.S. Cl. CPC H01M 10/54; C22B 7/005; C22B 7/006; H01M 4/366; H01M 4/525; H01M 2004/028

(57) ABSTRACT

Embodiments described herein relate to removal and addition of coatings from electrodes. In some aspects a method can include suspending an electrode mixture in a solvent, the electrode material including an electrode material and a coating material, agitating the electrode mixture via at least one of sonication or stirring, such that the coating material separates from the electrode material, and separating the electrode material from the conductive material. In some embodiments, the electrode material can include a binder and the solvent can dissolve the binder. In some embodiments, the electrode mixture is from a first electrode, and the method can further include removing a packaging from a battery and separating the first electrode from a second electrode and a separator. In some embodiments, the method can further include regenerating the active material. In some embodiments, the regenerating can include a heat treatment operation.

### CROSS-REFERENCE TO RELATED APPLICATIONS

This application is a Continuation of International Application No. PCT/US2023/082935, filed Dec. 7, 2023, entitled “Systems and Methods for Removal, Modification, and Addition of Coatings in Electroactive Materials,” which claims priority to and benefit of U.S. Provisional Patent Application No. 63/386,808, filed Dec. 9, 2022, entitled “Systems and Methods for Removal, Modification, and Addition of Coatings in Electroactive Materials,” the disclosure of which is hereby incorporated by reference in its entirety.

### TECHNICAL FIELD

Embodiments described herein relate to removal and addition of coatings in electroactive materials and systems for implementing such removals and additions.

### BACKGROUND

Lithium-ion batteries are a suitable energy storage solution for portable electronic devices, electric vehicles, and grid energy storage due to their low self-discharge rate, high energy/power density, and long cycle life. The market for lithium-ion batteries will continue to grow in the future. Therefore, the recycling of lithium-ion batteries is significantly important in terms of both environmental and economic benefits. Electrode materials, in particular, can benefit from recycling, especially methods such as direct recycling that directly recover and regenerate recycled electrode materials that are usable in new batteries. Coatings in electrodes can aid in preventing short circuiting, but they can hinder recycling of electrode material.

### SUMMARY

Embodiments described herein relate to removal and addition of coatings from electrodes. In some aspects, a method can include suspending an electrode mixture in a solvent, the electrode material including an electrode material and a coating material, agitating the electrode mixture via at least one of sonication or stirring, such that the coating material separates from the electrode material, and separating the electrode material from the conductive material. In some embodiments, the electrode material can include a binder and the solvent can dissolve the binder. In some embodiments, the electrode mixture is from a first electrode, and the method can further include removing a packaging from a battery and separating the first electrode from a second electrode and a separator. In some embodiments, the method can further include regenerating the active material. In some embodiments, the regenerating can include a heat treatment operation. In some embodiments, the regeneration can include a relithiation process. In some embodiments, the coating material is a first coating material and the method can further include coating the active material with a second coating material.

### BRIEF DESCRIPTION OF THE DRAWINGS

FIG. 1 is a flow diagram of a method of removing a coating from an electrode, according to an embodiment.

FIG. 2 is a block diagram of a system for removing a first coating from an electrode and applying a second coating to the electrode, according to an embodiment.

FIGS. 3A-3B show scanning electron microscopy (SEM) images of used cathode materials with and without coating removal.

FIGS. 4A-4B show SEM images of recycled cathode materials with and without coating removal.

FIG. 5 shows the electrochemical performance of recycled cathode materials with and without coating removal.

FIG. 6 shows the electrochemical performance of recycled cathode materials with and without coating addition.

### DETAILED DESCRIPTION

Electrode materials (especially cathode materials) of lithium-ion batteries can include doping, surface coating, or other modification to improve their electrochemical performance. Doping can alter the physical and chemical properties of electrode materials. This can include an increase in the electronic and ionic conductivity of the electrode, a decrease the cation mixing, and a strengthening of the transition metal oxide bond in the cathode. Dopants can include metal oxides, fluorides, phosphates, lithium composites, metals, and/or polymers. Surface coating can also alter the physical and chemical properties of electrode materials to create performance improvements. Such improvements can include improvement of the interface performance of the electrode materials, prevention of decomposition or oxidation, or reduction of the rate of decomposition or oxidation, of the electrolyte. This can improve the battery cycling stability. Other improvements include decreasing the water absorption rate by the electrode materials, which can increase the stability of the electrode materials.

Systems, apparatus, and methods described herein can be implemented for removing, modifying and adding additives, dopants, and surface coatings during the recycling of energy storage devices. In some embodiments, the recycling can include a coating/doping characterization operation, a coating removal operation, a regeneration and coating operation, a regeneration and doping operation, or any combination thereof. In some embodiments, the recycling technique can yield commercial-grade electrode materials (e.g., anode materials and/or cathode materials) that can be incorporated into a new battery. In some embodiments, recycling methods described herein can yield metal scrap (e.g., copper, aluminum, steel, or any combination thereof). In some embodiments, coating materials, such as metal oxides, fluorides, phosphates, lithium composites, metals, and polymers can be isolated and recovered.

During the recycling of lithium-ion batteries, the removal, modification, and addition of doping and surface coating can be important in altering or improving the quality or characteristics of the recycling electrode materials or assisting in the materials recovery process. Other modifications to lithium-ion batteries, such as separator coatings or current collector coatings, can be added, modified, or removed during the recycling process to benefit the quality or characteristics of the recovered battery components.

During the recycling and recovery of energy storage devices (e.g., lithium-ion batteries (LIBs)), direct recovery of the components of the LIBs can be advantageous. In some embodiments, the components can be redeployed in new LIBs in a direct recycling process. The electrode materials, including both cathode and anode materials, can benefit from the direct recycling process as such a process can reduce the cost or number of processing steps of recycling, as well as preserve beneficial properties of the anode and cathode materials.

The performance and characteristics of electrode materials can be altered via the use of doping and surface coatings. Modifications can also be made to other components such as the separator or current collectors. In some embodiments, modifications can be made directly to the LIB, including the application of coating layers. These modifications can be used in the synthesis of electrode materials or other LIB components, or during the manufacturing process of the LIB itself. For example, Li₂Si₂O₅-coated lithium nickel cobalt manganese oxide (NCM) cathode materials have been shown to improve electrochemical properties over uncoated NCM (Liu et al. Journal of Alloys and Compounds. 674 (2016) 447-454).

During the recycling of LIBs, especially when using direct recycling, benefits can be realized from adding, altering, or removing these modifications to the LIB or LIB components. The addition, alteration, or removal of these modifications can lead to altered or improved performance characteristics of the recovered materials. In some embodiments, these modifications can alter the direct recycling process of LIBs, including such alterations to make the LIBs more facile, or improve the operational effectiveness of certain direct recycling process steps.

Some embodiments described herein can include a coating/doping characterization operation, a coating removal operation, a coating modification operation, a doping modification operation, a regeneration and coating operation, and/or a regeneration and doping operation. In some embodiments, the recycling method can yield commercial-grade cathode and/or anode materials. In some embodiments, the recycling method can yield metal scrap (e.g., copper, aluminum, steel, or any combination thereof). In some embodiments, the recycling method yields other battery components, such as a separator, packaging, electrolyte, electrolyte salt, or any combination thereof. In some embodiments, coating materials, such as metal oxides, fluorides, phosphates, lithium composites, metals, and polymers can be isolated and recovered.

In some embodiments, electrode materials (i.e., anode and/or cathode materials) with or without coating or doping can be recycled as cathode or anode materials with new or altered coating or doping. In some embodiments, electrode materials with coating or doping are recycled as cathode or anode materials without coating or doping. Common cathode materials include lithium cobalt oxide (LCO), lithium nickel cobalt manganese oxide (NCM), lithium nickel cobalt aluminum oxide (NCA), lithium iron phosphate (LFP), and LFP-like cathode materials, and/or lithium manganese oxide (LMO). Cathode materials can include any of these materials, or other common cathode materials that have been modified with coatings and dopants and can include various compositions of these cathode materials. Common anode materials include graphite, lithium titanate, lithium metal, and silicon.

Coatings that are beneficial to the performance of a battery can in some cases present challenges to LIB recycling. These coatings can act as impurities and reduce the performance of regenerated electrode materials. These coatings can also prevent separation of the electrode materials from other materials (e.g., separators, current collectors). A coating removal operation can detach or dissolve the coatings from the electrode and remove the coatings by several separation methods such as filtration, fractionation, flotation, and centrifugation. The coatings can be separated from the electrode materials and either collected separately (either in its original form or reacted in some way to form new compounds) or discarded. In some embodiments, the coating to be removed exists on the surface of the electrode material particles. In some embodiments, the coating to be removed exists at the interface between the separator and the electrode material. In some embodiments, binders are used to attach the coating to the separator. In some embodiments, the binder can include polymethyl methacrylate (PMMA), polyvinylidene fluoride (PVDF), polyvinylidene fluoride hexafluoropropylene (PVDF-HFP), carboxymethyl cellulose (CMC), styrene-butadiene rubber (SBR), or any combination thereof.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of batteries, the plurality of batteries can be considered as multiple, distinct batteries or as one battery with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

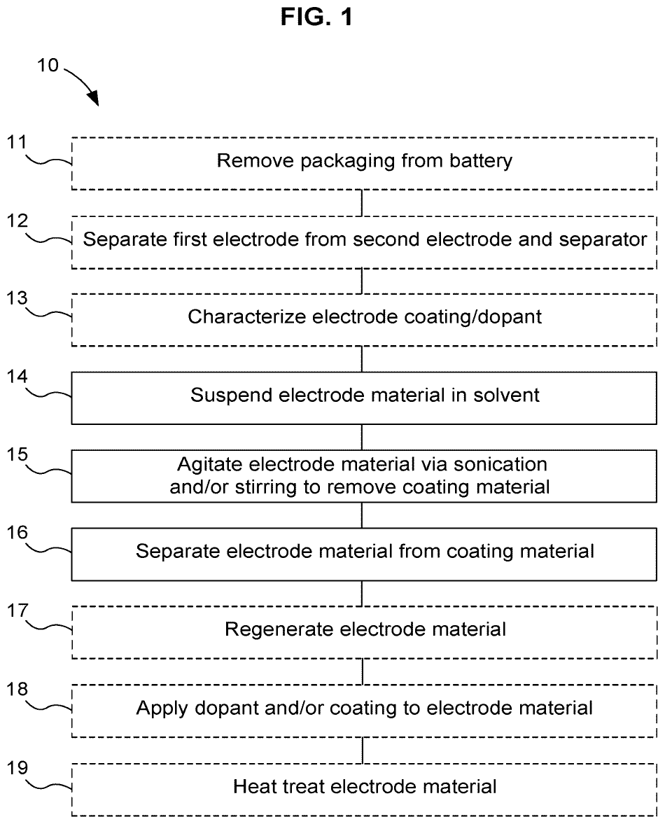

FIG. 1 is a flow diagram of a method 10 of removing a coating from an electrode, according to an embodiment. As shown, the method 10 optionally includes removing a packaging from a battery at step 11, separating a first electrode from a second electrode and a separator at step 12, and characterizing an electrode coating and/or dopant at step 13. The method 10 further includes suspending an electrode material in a solvent at step 14, agitating the electrode material via sonication and/or stirring to remove the coating material at step 15, and separating the electrode material from the coating material at step 16. The method 10 optionally includes regenerating the electrode material at step 17, applying a dopant and/or a coating to the electrode material at step 18, and heat treating the electrode material at step 19.

Step 11 is optional and includes removing a packaging from a battery. In some embodiments, the removal can be via a blade that cuts the packaging of the battery. In some embodiments, the removal can be via a grabbing device that retrieves packaging peeled away from the other components of the battery. In some embodiments, step 11 can include removing packaging from a system of batteries and the system of batteries can be further processed in accordance with the method 10. In some embodiments, the system of batteries can further include one or more battery modules that comprise multiple battery cells or units. In these embodiments, the removal can include the manual or automatic disassembly of the system of batteries into at least one individual battery. The at least one individual battery can undergo the removal of packaging, as described above.

Step 12 is optional and includes separating a first electrode from a second electrode and a separator. In some embodiments, the first electrode can be separated from the second electrode and the separator via an agitator. In some embodiments, the first electrode can be separated from the second electrode and the separator via stirring. In some embodiments, a solvent can be used to separate the first electrode from the second electrode and the separator. After separating, the first electrode and/or the second electrode can proceed for further processing.

Step 13 is optional and includes characterizing the coating and/or dopant on the electrode material. Step 13 can include a coating/doping characterization operation that determines if the electrode material (or in some embodiments, other battery components) have coating or doping and determine the type of coating or doping. In some embodiments, the structure, chemical composition, and/or other properties of the coating, dopant, or other modifications on the electrode materials (or other battery components) can be examined. In some embodiments, the dopant and/or coating of the electrode materials in the battery are known before the method 10 is executed.

In some embodiments, the electrode material can include electrode active material. In some embodiments, the electrode material can include conductive material. In some embodiments, the characterizing can include a coating/dopant characterization operation that determines if the electrode materials (and/or other battery components) have coating or dopant and determine the type of coating or dopant. In some embodiments, the characterizing can be non-destructive. In some embodiments, the characterizing can utilize (i.e., consume) a small amount of the electrode materials. In some embodiments, the coating/dopant characterization can include the use of a scanning electron microscope to check the surface morphology of the electrode material. In some embodiments, in conjunction with scanning electron microscopy (SEM), energy dispersive X-ray spectroscopy (EDX or EDS) can be used to assess the elemental composition of the electrode materials to determine the presence of coating or dopant. In some embodiments, the coating/dopant characterization operation can include transmission electron microscopy (TEM) to observe the structure and profile of electrode materials. In some embodiments, the coating/dopant characterization operation can include X-ray photoelectron spectroscopy (XPS) to determine the elemental composition and chemical state on the surface of the electrode material. In some embodiments, the coating/dopant characterization operation can include X-ray diffraction (XRD) (which also includes techniques such as Rietveld refinement and small-angle and wide-angle XRD) to reveal the crystal structure of the electrode material, including crystal structure and lattice parameter. In some embodiments, the coating/dopant characterization operation can include inductively coupled plasma mass spectrometry (ICP-MS) analysis on the solutions with dissolved electrode materials. In some embodiments, the characterization of electrode coating/dopant can be performed via any combination of the techniques described above.

In some embodiments, the coating can include a combination of one or more metal atoms with one or more elements of carbon, nitrogen, oxygen, and sulfur. In some embodiments, the coating can include Al₂O₃ and/or SiO₂.

Step 14 includes suspending an electrode material in a solvent. The electrode material can be coupled to a coating (i.e., the coating/dopant referenced in step 13). In some embodiments, the electrode material and the coating can be included in an electrode mixture. In some embodiments, the electrode material can include a mixed electrode powder, a cathode powder, and/or an anode powder. In some embodiments, the electrode mixture can include a separator, a current collector, a battery packaging, or pieces thereof.

The electrode material and the solvent can form a suspension. In some embodiments, the solvent can be used to at least partially disassociate the active material from the binder. In some embodiments, the solvent can at least partially dissolve the coating. In some embodiments, the solvent can at least partially dissolve a binder holding the coating to the active material. In some embodiments, the solvent can include a binder-dissolving solvent used to dissolve the binder partly or entirely. In some embodiments, the coating can be removed before the binder. In some embodiments, the coating can be removed from the electrode material after the binder is removed but before a purification/regeneration process (i.e., step 17). In some embodiments, the coating removal process is performed multiple times throughout the method 10.

In some embodiments, chemical and/or physical modifications can be made to the coating before removing the coating. In some embodiments, chemical and/or physical modifications can be made to the coating before, during or after the purification/regeneration process. In some embodiments, the coating removal can be performed simultaneously with either of the other processes of the method and/or via the same equipment (e.g., in the same reactor).

In some embodiments, the battery can include a solid-state electrolyte. In some embodiments, the solid-state electrolyte can be removed via the solvent. In some embodiments, the solid-state electrolyte can be removed via liquid washing. In some embodiments, the solid-state electrolyte can include a sulfide-based electrolyte and the liquid used to wash the solid-state electrolyte can include a polar solvent (e.g., ethanol, acetonitrile). In some embodiments, the solid-state electrolyte can include lithium argyrodites with the composition Li₆PS₅X, wherein X is chlorine (Cl), bromine (Br), or iodine (I). In some embodiments, the solid-state electrolyte can include sulfide-based PS₄³⁻ thiophosphates.

Step 15 includes agitating the electrode material via sonication and/or stirring to remove the coating material. In some embodiments, the sonication and/or the stirring can occur in a bath of the solvent, as described above with reference to step 14. In some embodiments, the coating can be detached entirely or partly from the electrode materials by sonication. In some embodiments, the sonication can include ultrasonication. In some embodiments, the coating can be detached entirely or partly from the electrode material by high-energy milling. In some embodiments, the coating can be detached entirely or partly from the electrode material by high-energy grinding.

Step 16 includes separating the electrode material from the coating material. In some embodiments, the detached coating can be separated from the electrode material by particle size differences (e.g., via sieving, filtration fractionation, air classification, or any combination thereof). In some embodiments, the detached coating and/or coating still bonded to the electrode material can be separated from the electrode material by different densities (e.g., via centrifugation, pneumatic jigging and shaking, air tables, air-fluidized beds, or any combination thereof). In some embodiments, the detached coating and/or coating still bonded to the electrode material can be separated from the electrode material based on thermal stabilities between the electrode material and the coating (e.g., via thermal decomposition). In some embodiments, the detached coating and/or coating still bonded to the electrode material can be separated from the electrode material based on differing hydrophilicities between the coating and the electrode material (e.g., via flotation). In some embodiments, the detached coating and/or coating still bonded to the electrode material can be separated from the electrode materials based on differing chemical stabilities between the coating and the electrode material (e.g., by reacting the electrode material and the coating with chemicals). In some embodiments, the detached coating and/or coating still bonded to the electrode material can be separated from the electrode material based on differing static properties between the coating and the electrode material (e.g., via static separation). In some embodiments, other density-, weight-, or particle size-based separation methods can be utilized to separate the coating from the electrode material.

In some embodiments, the coating at the interface of the separator and a sheet of electrode material can be removed by washing with solvents including, but not limited to, N,N-dimethylformamide (DMF), N-methyl-2-pyrrolidone (NMP), and cyrene. The sheet of electrode material can be rinsed or gently washed with solvents to detach the interfacial coating from the electrode structure, leaving the electrode material separated from the separator and free of coating.

In some embodiments, the coating can form a suspension in the solvent by sonication and can be separated from the electrode material by separation methods. In some embodiments, the separation methods include field flow fractionation, tangential flow filtration, and centrifugation (or other density-, weight-, or particle size-based separation methods). In some embodiments, the coating comprises a combination of one or more metal atoms with one or more elements of carbon, nitrogen, oxygen, and sulfur. In some embodiments, the coating can include Al₂O₃ or SiO₂. In some embodiments, the electrode material can include pieces of separator or other impurities. In some embodiments, the coating can be extracted for reuse and/or further processing. In some embodiments, the coating can be discarded.

Step 17 is optional and includes regenerating the electrode material. Step 18 is optional and includes applying dopant and/or coating to the electrode material. Step 19 is optional and includes heat treating the electrode material. Steps 17, 18, and 19 can occur in any order, and can occur at least partially concurrently. Electrode materials with or without existing coating can undergo a coating operation to add new coating or modify an existing coating using a variety of methods. A regeneration and doping operation recovers the structural defects and compositional losses of the electrode materials and also adds new composition to the lattice or bulk of the electrode materials (doping).

A regeneration operation can aid in recovering structural defects and/or compositional losses of the electrode material. In some embodiments, the regeneration of the electrode material can include a heat treatment operation. In some embodiments, the heat treatment operation increases the purity of the electrode materials by thermally decomposing or vaporizing carbon or other organic compounds present in the recovered material mixture. In some embodiments, the regeneration process can include a relithiation process to compensate for the lithium losses from the electrode material. In some embodiments, the relithiation of the electrode material is completed via solid-state synthesis during the heat treatment. In some embodiments, the relithiation process can include homogeneously mixing the electrode materials with one or more types of lithium sources, such as lithium carbonate and/or lithium hydroxide (including lithium hydroxide monohydrate), prior to the heat treatment. In some embodiments, the lithium source can be mixed thoroughly with the electrode material.

In some embodiments, the regeneration and the coating operation can be performed in isolation with no other regeneration operations in a direct recycling system. In some embodiments, a regeneration and coating operation can be performed in combination with other regeneration operations in a direct recycling system. A regeneration and doping operation can include the regeneration of electrode materials. In some embodiments, the regeneration and doping operation can be performed in isolation with no other regeneration operations in a direct recycling system. In some embodiments, a regeneration and doping operation can be performed in combination with other regeneration operations in a direct recycling system.

In some embodiments, the doping operation is performed by a solid-state reaction. In some embodiments, the doping can be completed via chemical reactions from solid starting materials. In some embodiments, the doping process can completed via the heat treatment. In some embodiments, the doping operation can be performed via a hydrothermal method. Aqueous solutions containing doping elements can react with electrode materials in a pressure vessel at high temperature to complete the doping process. In some embodiments, the dopant and/or the coating can bond to the surface of the electrode material. In some embodiments, the dopant and/or coating can be formed from existing coating material on the surface of the electrode material. In some embodiments, the dopant and/or the coating can be generated from the addition of coating precursors. In some embodiments, the coating operation can be performed via a mechanical fusion method. In some embodiments, chemical reactions can be induced between the coating/dopant and the electrode material via strong mechanical energy. In some embodiments, the application of the dopant and/or the coating can be via mixing particles together vigorously such that the particles fuse together. In some embodiments, chemical reactions can be induced via strong mechanical energy. In some embodiments, the mechano-chemical reactions between multiple particles can create new particles as electrode coatings.

In some embodiments, the mixing of the electrode particles and the coating/dopant can be under an applied pressure. An applied pressure can influence reaction kinetics. In some cases, an applied pressure can create other material structures. In some embodiments, the applied pressure during mixing can be at least about 10 kPa (gauge), at least about 20 kPa, at least about 30 kPa, at least about 40 kPa, at least about 50 kPa, at least about 60 kPa, at least about 70 kPa, at least about 80 kPa, at least about 90 kPa, at least about 100 kPa, at least about 200 kPa, at least about 300 kPa, at least about 400 kPa, at least about 500 kPa, at least about 600 kPa, at least about 700 kPa, at least about 800 kPa, at least about 900 kPa, at least about 1,000 kPa, at least about 2,000 kPa, at least about 3,000 kPa, at least about 4,000 kPa, at least about 5,000 kPa, at least about 6,000 kPa, at least about 7,000 kPa, at least about 8,000 kPa, or at least about 9,000 kPa. In some embodiments, the applied pressure during mixing can be no more than about 10,000 kPa, no more than about 9,000 kPa, no more than about 8,000 kPa, no more than about 7,000 kPa, no more than about 6,000 kPa, no more than about 5,000 kPa, no more than about 4,000 kPa, no more than about 3,000 kPa, no more than about 2,000 kPa, no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, no more than about 90 kPa, no more than about 80 kPa, no more than about 70 kPa, no more than about 60 kPa, no more than about 50 kPa, no more than about 40 kPa, no more than about 30 kPa, or no more than about 20 kPa. Combinations of the above-referenced applied pressures are also possible (e.g., at least about 10 kPa and no more than about 10,000 kPa or at least about 500 kPa and no more than about 5,000 kPa), inclusive of all values and ranges therebetween. In some embodiments, the applied pressure during mixing can be about 10 kPa, about 20 kPa, about 30 kPa, about 40 kPa, about 50 kPa, about 60 kPa, about 70 kPa, about 80 kPa, about 90 kPa, about 100 kPa, about 200 kPa, about 300 kPa, about 400 kPa, about 500 kPa, about 600 kPa, about 700 kPa, about 800 kPa, about 900 kPa, about 1,000 kPa, about 2,000 kPa, about 3,000 kPa, about 4,000 kPa, about 5,000 kPa, about 6,000 kPa, about 7,000 kPa, about 8,000 kPa, about 9,000 kPa, or about 10,000 kPa.

In some embodiments, the application of dopant and/or coating to the electrode material can be via a sol-gel method. A colloidal solution can be formed with coating precursors and can gradually evolve toward an integrated network or gel. In some embodiments, the formation of the coating/dopant on the electrode material can be completed via a heat treatment process. In some embodiments, the coating operation can be performed via a co-precipitation method. Precipitation agents are added to the solution to generate coating materials on the electrode surface by precipitation. The formation of the coating is completed by a heat treatment process.

In some embodiments, the coating operation can be via chemical vapor deposition. A gaseous or liquid reactant containing the desired coating element is introduced into a reaction chamber. Then a solid-state membrane material is deposited on the electrode material surface by heating the solid substrate through a specific chemical reaction with mixed vapor. In some embodiments, the coating operation can be via organic pyrolysis. Organic coating materials can be homogeneously mixed with the electrode materials and the formation of the coating is completed by a heat treatment process.

In some embodiments, the coating operation can be via chemical plating. The metal ions are reduced through autocatalysis and deposited on the surface of the electrode materials. In some embodiments, the coating operation can be performed via physical vapor deposition, plasma-enhanced chemical vapor deposition, electrochemical plating, and/or other similar coating methods.

In some embodiments, the coating formed in step 18 can include an oxide. In some embodiments, the coating can include magnesium oxide (MgO), silicon dioxide (SiO₂), aluminum oxide (Al₂O₃), titanium oxide (TiO₂), zinc oxide (ZnO), zirconium oxide (ZrO₂), cerium oxide (CeO₂), rubidium oxide (RuO₂) diboron trioxide (B₂O₃), cobalt oxide (Co₃O₄), molybdenum oxide (MoO₃), or any combination thereof. In some embodiments, the coating formed in step 18 can include a nitride. In some embodiments, the coating can include titanium nitride (TiN), boron nitride (BN), silicon nitride (SiN), vanadium nitride (VN), or any combination thereof. In some embodiments, the coating formed in step 18 can include a carbonate. In some embodiments, the coating can include lithium carbonate (Li₂CO₃), sodium carbonate (Na₂CO₃) potassium carbonate (K₂CO₃), or any combination thereof. In some embodiments, the coating formed in step 18 can include a sulfate. In some embodiments, the coating can include lithium sulfate (Li₂SO₄). In some embodiments, the coating formed in step 18 can include a fluoride. In some embodiments, the coating can include lithium fluoride (LiF), magnesium fluoride (MgF₂), aluminum fluoride (AlF₃), calcium fluoride (CaF₂), yttrium fluoride (YF₃), lanthanum trifluoride (LaF₃), cerium fluoride (CeF₃), lithium aluminum fluoride (LiAlF₄), or any combination thereof. In some embodiments, the coating formed in step 18 can include a phosphate. In some embodiments, the coating can include iron phosphate (FePO₄), aluminum phosphate (AlPO₄), cobalt phosphate (Co₃(PO₄)₂), lithium phosphate (Li₃PO₄), lanthanum phosphate (LaPO₄), cerium phosphate (CePO₄), or any combination thereof. In some embodiments, the coating formed in step 18 can include a lithium composite. In some embodiments, the coating can include lithium aluminum oxide (LiAlO₂), lithium silicate (LiSi₂O₅), lithium titanate (Li₂TiO₃), lithium zirconate (Li₂ZrO₃), lithium iron phosphate (LiFePO₄), lithium cobalt oxide (LiCoO₂), or any combination thereof. In some embodiments, the coating formed in this step 18 can include carbon-based materials. In some embodiments, the coating can include porous carbon, carbon nanowires, graphene, carbon nanotubes, or any combination thereof. In some embodiments, the coating formed in step 18 can include a metal. In some embodiments, the coating can include aluminum (Al), silver (Ag), gold (Au), or any combination thereof.

In some embodiments, the coating and/or dopant can be added to the lattice or bulk of the electrode material. In some embodiments, the coating and/or dopant added to the lattice or bulk of the electrode material can include nonmetals. In some embodiments, the coating and/or dopant can include boron (B), fluorine (F), sulfur (S), Br, or any combination thereof. In some embodiments, the coating and/or dopant can include a general metal. In some embodiments, the coating and/or dopant can include magnesium (Mg), aluminum (Al), titanium (Ti), chromium (Cr), iron (Fe), cobalt (Co), nickel (Ni), copper (Cu), zinc (Zn), gallium (Ga), zirconium (Zr), rubidium (Ru), Ag, tin (Sn), vanadium (V), Au, or any combination thereof. In some embodiments, the coating and/or dopant can include a rare-earth metal. In some embodiments, the coating and/or the dopant can include lanthanum (La), cerium (Ce), praseodymium (Pr), neodymium (Nd), samarium (Sm), gadolinium (Gd), or any combination thereof. In some embodiments, the coating and/or dopant can include an actinide dopant. In some embodiments, the coating and/or dopant can include thorium (Th) and/or uranium (U). In some embodiments, multiple dopants can be added to the electrode material.

In some embodiments, the raw materials used in the coating/doping operation can include carbonates, acetates, nitrates, sulfates, hydroxides, and/or oxides of the dopants. In some embodiments, the molar ratio of the coating/dopant compared to lithium can be at least about 0:100, at least about 1:100, at least about 2:100, at least about 3:100, at least about 4:100, at least about 5:100, at least about 6:100, at least about 7:100, at least about 8:100, at least about 9:100, at least about 10:100, at least about 11:100, at least about 12:100, at least about 13:100, or at least about 14:100. In some embodiments, the molar ratio of the coating/dopant compared to lithium can be no more than about 15:100, no more than about 14:100, no more than about 13:100, no more than about 12:100, no more than about 11:100, no more than about 10:100, no more than about 9:100, no more than about 8:100, no more than about 7:100, no more than about 6:100, no more than about 5:100, no more than about 4:100, no more than about 3:100, no more than about 2:100, or no more than about 1:100. Combinations of the above-referenced ratios are also possible (e.g., at least about 1:100 and no more than about 15:100 or at least about 3:100 and no more than about 10:100), inclusive of all values and ranges therebetween. In some embodiments, the molar ratio of the coating/dopant compared to lithium can be about 0:100, about 1:100, about 2:100, about 3:100, about 4:100, about 5:100, about 6:100, about 7:100, about 8:100, about 9:100, about 10:100, about 11:100, about 12:100, about 13:100, or about 14:100, or about 15:100. In some embodiments, the molar concentration of the coating and/or dopant in a mixture of the dopant/coating and the lithium can be about 0% to about 1%, about 1% to about 2%, about 2% to about 3%, about 3% to about 4%, about 4% to about 5%, about 5% to about 6%, about 6% to about 7%, about 7% to about 8%, about 8% to about 9%, about 9% to about 10%, about 10% to about 11%, about 11% to about 12%, about 12% to about 13%, about 13% to about 14%, or about 14% to about 15%.

In some embodiments, the depth of doping modification varies. In some embodiments, the coating and/or dopant can be added to the surface of the electrode materials. In some embodiments, the coating and/or dopant can be added to the bulk of the electrode material. In some embodiments, the coating and/or the dopant can be added to both the surface and the bulk of the electrode material. In some embodiments, the regeneration of the electrode materials and the formation of a new crystal structure with the dopants are performed simultaneously.

In some embodiments, the method 10 can include a coating modification operation. A coating modification operation, which can include the modification of coating from one form to another or the addition of a new coating, can alter the coating/dopant. This coating modification can lead to changes in the properties of the electrode material including, but not limited to, the particle size, particle shape, particle distribution, chemical composition, electrochemical performance (e.g., capacity, cycling life, temperature-dependent performance, high-rate performance), electronic or ionic conductivity, mechanical properties, and manufacturability in batteries. In some embodiments, the coating modification can be performed before applying the coating to the electrode material. In some embodiments, the coating modification can be performed after applying the coating to the electrode material.

In some embodiments, the coating modification can be performed via physical methods. In some embodiments, mechanical force can be applied to the coating to modify the size, shape and distribution of the coating. In some embodiments, high-energy milling can cleave particles or particle agglomerations to create new surfaces without coating. In some embodiments, a high-intensity, high-speed, or high-energy mixer or mechanical fusion device can modify the coating. In some embodiments, the coating modification can be performed by chemical methods.

In some embodiments, the coating can be applied directly to the particles of the electrode material by mixing, milling, washing, or other related method. The coating can be bound to the electrode material via electrostatic, van der Waals, and/or ionic forces. In some embodiments, the coating directly reacts with the surface of the electrode material. In some embodiments, the coating can be applied after heat treatment or regeneration of the electrode material.

In some embodiments, the lithium source and the coating precursor can be added together and mixed thoroughly with the electrode material. In some embodiments, the lithium source and the coating precursor can be added together and mixed thoroughly with the electrode material, and the regeneration and coating operation is completed via heat treatment. In some embodiments, only the coating precursor can be added to the electrode materials in solid or liquid form, and the regeneration and coating operation is completed by heat treatment. In some embodiments, the coating precursors can be added using methods such as mechanical fusion, sol-gel, co-precipitation, or any combination thereof.

In some embodiments, coating precursors are first added to the electrode materials in solid or liquid form via mechanical fusion, sol-gel, co-precipitation, or any combination thereof. A first heat treatment can form the coating on the surface of the electrode material. Then a second heat treatment can complete the regeneration of the electrode material to restore other properties such as lithium stoichiometry and particle structure. In some embodiments, one or more types of lithium sources can be added and mixed with the electrode material before the second heat treatment to compensate for the lithium loss in the electrode material.

In some embodiments, a heat treatment can be performed on the electrode material and the coating during the mechanical fusion process. In some embodiments, the mechanical fusion can be performed at a temperature of at least about 400° C., at least about 500° C., at least about 600° C., at least about 700° C., at least about 800° C., at least about 900° C., at least about 1,000° C., or at least about 1,100° C. In some embodiments, the mechanical fusion can be performed at a temperature of no more than about 1,200° C., no more than about 1,100° C., no more than about 1,000° C., no more than about 900° C., no more than about 800° C., no more than about 700° C., no more than about 600° C., or no more than about 500° C. Combinations of the above-referenced temperatures are also possible (e.g., at least about 400° C. and no more than about 1,200° C. or at least about 600° C. and no more than about 900° C.), inclusive of all values and ranges therebetween. In some embodiments, the mechanical fusion can be performed at a temperature of about 400° C., about 500° C., about 600° C., about 700° C., about 800° C., about 900° C., about 1,000° C., about 1,100° C., or about 1,200° C.

In some embodiments, a mechanical fusion machine can aid in dry coating cathode material at lower temperatures. In some embodiments, the mechanical fusion machine can dry coat cathode material and/or anode material at a temperature of at least about 20° C., at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., or at least about 190° C. In some embodiments, the mechanical fusion machine can dry coat cathode material and/or anode material at a temperature of no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., or no more than about 30° C. Combinations of the above-referenced temperatures are also possible (e.g., at least about 20° C. and no more than about 200° C. or at least about 50° C. and no more than about 100° C.), inclusive of all values and ranges therebetween. In some embodiments, the mechanical fusion machine can dry coat cathode material and/or anode material at a temperature of about 20° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., or about 190° C., about 200° C.

In some embodiments, the mechanical fusion can be conducted in an inert atmosphere. An inert atmosphere can be of particular value in a mechanical process involving LFP battery chemistry. In some embodiments, the inert atmosphere can include argon (Ar), nitrogen (N₂), and/or (CO₂).

In some embodiments, the coating can be formed via a chemical reaction. In other words, the coating precursors can chemically react to form a compound that at least partially forms the coating. For example, lithium hydroxide (LiOH), lithium carbonate (Li₂CO₃), or lithium oxides (Li₂O or LiO₂) can react with metasilicic (H₂O₃Si) or orthosilicic acid (H₄SiO₄) to generate lithium silicate (Li₂Si₂O₅) coating. In another example, Si(OC₂H₅)₄ can be used in combination with a solvent such as water to react with lithium hydroxide, lithium carbonate, or lithium oxides to form a lithium metasilicate (Li₂SiO₃) coating. In some embodiments, mechanical fusion can be applied during such a reaction to directly mix and heat the coating precursors (e.g., to a temperature between about 500° C. and about 900° C.) in the fusion machine to generate the coating.

In some embodiments, the first heat treatment can be performed on the electrode material before adding the coating precursors. Coating precursors (which can include chemical precursors and/or any of the coating materials listed above with respect to step 18) can then be mixed with the electrode material. Then a second heat treatment can performed on the electrode material to complete the regeneration and coating operation. In some embodiments, the first heat treatment can be performed at various temperatures and lengths of time. These parameters can change depending on the type of electrode materials and coating materials. In some embodiments, the first heat treatment is performed at a temperature of at least about 400° C., at least about 500° C., at least about 600° C., at least about 700° C., at least about 800° C., at least about 900° C., at least about 1,000° C., or at least about 1,100° C. In some embodiments, the second heat treatment operation is performed at a temperature of no more than about 1,200° C., no more than about 1,100° C., no more than about 1,000° C., no more than about 900° C., no more than about 800° C., no more than about 700° C., no more than about 600° C., or no more than about 500° C. Combinations of the above-referenced temperatures are also possible (e.g., at least about 400° C. and no more than about 1,200° C. or at least about 600° C. and no more than about 900° C.), inclusive of all values and ranges therebetween. In some embodiments, the second heat treatment operation can be performed at a temperature of about 400° C., about 500° C., about 600° C., about 700° C., about 800° C., about 900° C., about 1,000° C., about 1,100° C., or about 1,200° C.

In some embodiments, residual lithium in the electrode material after the first heat treatment can be washed off by a liquid such as water or ethanol. In some embodiments, the coating/doping precursors can be directly added to the electrode materials in solid or liquid form via mechanical fusion, sol-gel, co-precipitation, or any combination thereof. In some embodiments, additional coating precursors can be formed via chemical reactions of added coating precursors with the residual lithium in the electrode materials. One or more agents can be added to react with the residual lithium in the electrode materials. In some embodiments, the residual lithium can include lithium carbonate and/or lithium hydroxide. In some embodiments, the agent added to react with the residual lithium can include orthosilicic acid.

In some embodiments, the first heat treatment forms the new lattice for the electrode materials. In some embodiments, a second heat treatment completes the regeneration of the electrode materials. In some embodiments, one or more types of lithium sources are added and mixed with the electrode materials before the second heat treatment to compensate for the lithium loss in the electrode materials.

In some embodiments, surface coating layers are also formed during the doping operation. In some embodiments, dopant ions form a lithium composite oxide coating on the surface of the electrode materials during the doping. In some embodiments, the dopant ions can include, but are not limited to, Zr⁴⁺, Ge⁴⁺, and PO₄³⁻.

In some embodiments, the surface coating layers can form on the electrode material under controlled heating temperatures during doping. In some embodiments, zirconium oxide (Zr₂O) coating can form during the Zr doping for electrode materials when the sintering temperature is at least about 700° C. In some embodiments, doping can form in electrode materials under specific heating protocols during the coating operation. In some embodiments, a lower temperature pre-heating before the final sintering for coating can also dope certain elements into the electrode material. In some embodiments, the doped element can include Ti. In some embodiments, the surface coating can form on electrode materials under controlled heating atmosphere during doping. In some embodiments, electrode materials mixed with precursors sintered in the air can result in the formation of surface coating. In some embodiments, electrode materials mixed with precursors sintered in oxygen or other oxidizing atmosphere result in the formation of coating and doping to the electrode material. In some embodiments, the coating precursors and doping precursors can add and mix together with electrode material before the heat treatment. Both the surface coating and doping can form on electrode material after the heat treatment.

In some embodiments, at least one of the first heat treatment or the second heat treatment is executed in flowing gas. In some embodiments, at least one of the first heat treatment or the second heat treatment is executed in stagnant gas. In some embodiments at least one of the first heat treatment and the second heat treatment is operated in a reducing, oxidizing, or inert atmosphere. In some embodiments, at least one of the first heat treatment or the second heat treatment can be operated in an environment including Ar, N₂, oxygen (O₂), CO₂, carbon monoxide (CO), hydrogen (H₂), or a combination thereof. In some embodiments, the coating and/or dopant can be characterized after the regeneration and/or coating.

In some embodiments, one or more coating and doping methods mentioned above can be used in any combination and in any order to generate an electrode material that has at least one of a new coating, a new doping composition, a modified coating, a modified doping composition, the removal of a coating, or the removal of a doping composition.

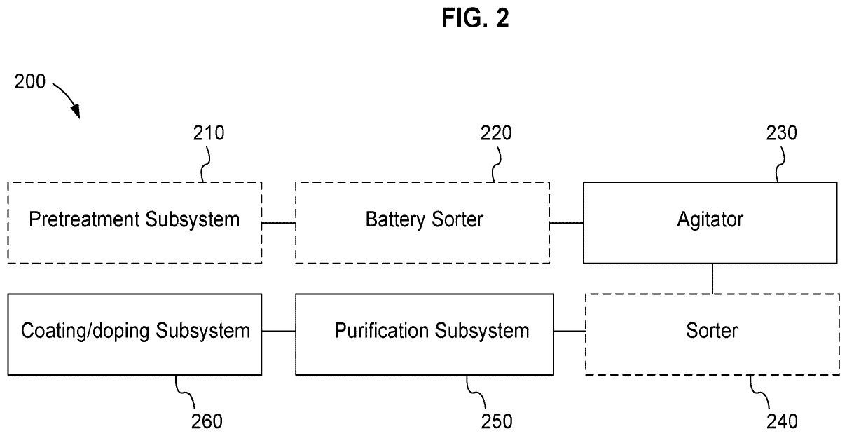

FIG. 2 is a block diagram of a system 200 for removing a first coating from an electrode and applying a second coating to the electrode, according to an embodiment. As shown, the system 200 optionally includes a pretreatment system 210 and a battery sorter 220. The system 200 includes an agitator 230. The system 200 optionally includes a sorter 240. The system 200 further includes a purification subsystem 250 and a coating/doping subsystem 260. In some embodiments, a conveyor can transport batteries and portions of batteries between the different process units of the system 200. In some embodiments, the system 200 can include any of the instrumentation described in U.S. Patent Publication No. 2022/0029217 (“the '217 publication”), filed Nov. 26, 2019 and titled, “Methods and Systems for Scalable Direct Recycling of Batteries,” the disclosure of which is hereby incorporated by reference in its entirety. In some embodiments, the system 200 can include any of the instrumentation described in U.S. Provisional Patent Application No. 63/340,612 (“the '612 application”), filed May 11, 2022 and titled, “Methods and Systems for Scalable Direct Recycling of Battery Waste,” the disclosure of which is hereby incorporated by reference in its entirety.

In the pretreatment subsystem 210, spent batteries are processed to remove casings and pouch materials from the batteries. In some embodiments, the pretreatment subsystem 210 can include instrumentation to discharge the battery to remove electrical charge. In some embodiments, the pretreatment subsystem 210 can include grinders and/or shredders to break down the battery into smaller pieces. In some embodiments, the pretreatment subsystem 210 can include one or more blades to cut the casing and/or pouch from the batteries. In some embodiments, the pretreatment subsystem 210 can include a flat surface to peel the casing and/or pouch away from the rest of the battery. In some embodiments, the pretreatment subsystem 210 can include a grabbing device (e.g., a clamp) to pull the casing and/or the pouch away from the rest of the battery. In some embodiments, the pretreatment subsystem 210 can include instrumentation to separate a first electrode in the battery from a second electrode and a separator. In some embodiments, the pretreatment subsystem 210 can include binder removal instrumentation (e.g., solvent washing or heat treatment application).

The battery sorter 220 sorts batteries based on the coatings they include on their electrodes (i.e., the same or substantially similar to step 15, as described above with reference to FIG. 1). In some embodiments, the battery sorter 220 can include any of the instrumentation used for sorting, as described above in step 13 with respect to FIG. 1. In some embodiments, the battery sorter 220 can include instrumentation for SEM, EDX, EDS, TEM, XPS, XRD, ICP-MS, or any combination thereof. In some embodiments, multiple coating/doping characterization instruments can be placed at various locations throughout the system 200.

The agitator 230 applies an agitating force to electrode material to separate the coating material from an active material. The electrode material can be received from the battery sorter 220 and/or the pretreatment subsystem 210. In some embodiments, the agitator 230 can include a sonicator. In some embodiments, the agitator 230 can include a sonication bath. In some embodiments, the agitator 230 can include a stirrer. In some embodiments, the agitator 230 can include a vibration device. In some embodiments, the agitator 230 can include an agitation rack. In some embodiments, the agitator 230 can include an impeller. In some embodiments, the agitator 230 can include a mixing paddle.

The sorter 240 separates the electrode material from the coating material. In some embodiments, the sorter 240 can include a settling tank. In some embodiments, the sorter 240 can include a filter or a series of filters. In some embodiments, the sorter 240 can include a flotation tank. In some embodiments, the sorter 240 can include a centrifuge. In some embodiments, the sorter 240 can include a splitter that separates the coating material from the electrode material. In some embodiments, the sorter 240 can include a decanter.

The purification subsystem 250 can include instrumentation for regenerating the electrode material. In some embodiments, the purification subsystem 250 can include instrumentation for heat treatment. In some embodiments, the purification subsystem 250 can include an oven and/or a furnace.

At the coating/doping subsystem 260, coating is reapplied to the electrode material. In some embodiments, the coating/doping subsystem 260 can include instrumentation for sintering. In some embodiments, the coating/doping subsystem 260 can include an oven and/or a furnace. In some embodiments, the coating/doping subsystem 260 can include a mechanical fusion machine.

### EXAMPLES

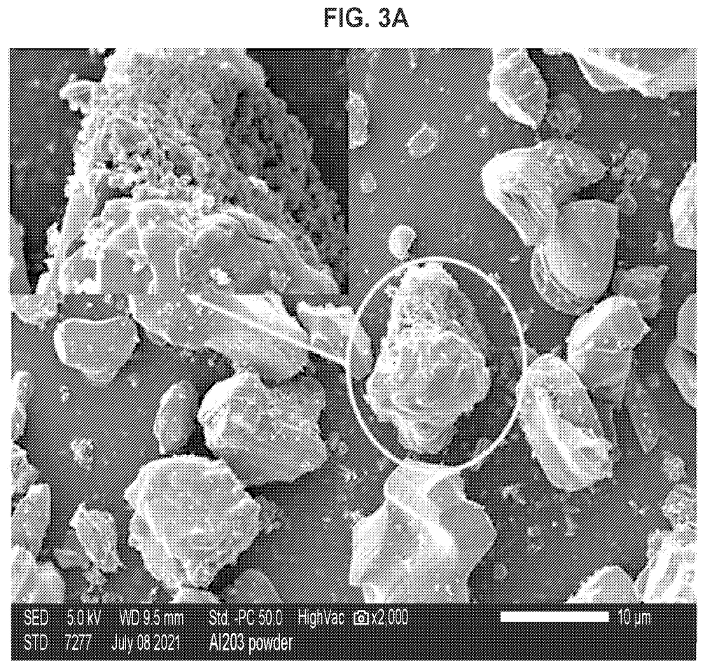

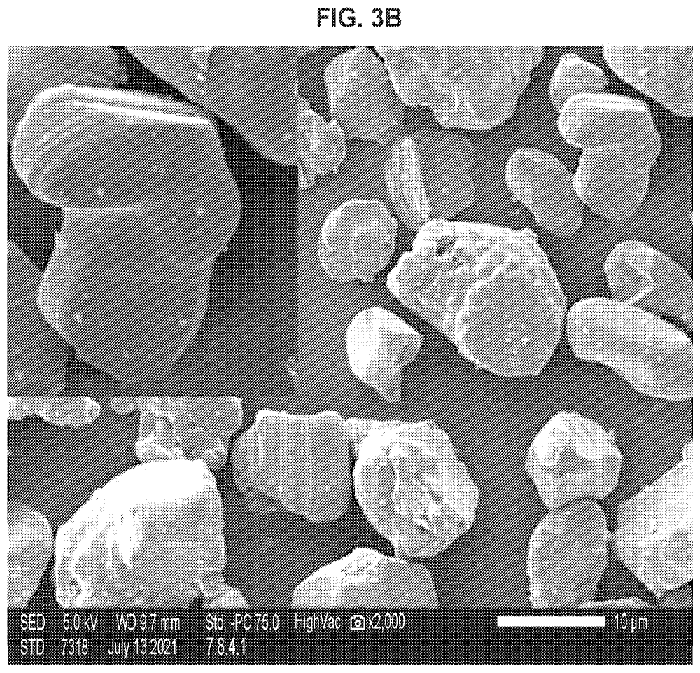

FIGS. 3A-3B show SEM images of used cathode materials with and without coating removal. The example shown in FIGS. 3A-3B pertains to the removal of Al₂O₃ coating on LiCoO₂ (LCO) cathode material during the recycling of end-of-life lithium-ion batteries. The coating removal was performed after the cathode materials extraction but before the cathode materials regeneration. The LiCoO₂ cathode materials were extracted from the end-of-life lithium-ion batteries by solvent washing and filtration. The solvent used for washing included a combination of water, other aqueous solvent, dimethylformamide (DMF), N-Methyl-2-pyrrolidone (NMP), and cyrene. A detailed description of the aforementioned recycling operations, including the regeneration operations, can be found in the '217 publication and the '612 application. The collected cathode materials, mixed with Al₂O₃ coating materials, were suspended in solvent by stirring. The suspension was then sonicated, and the cathode materials precipitated faster than the Al₂O₃ coating materials. The top liquid at the surface was decanted, which contained primarily the Al₂O₃ coating materials. The process was repeated several times via addition of additional solvent, sonication, and top liquid removal, to remove Al₂O₃ coating materials mixed in the cathode materials. Then a regeneration operation completed the recycling process to generate recycled cathode materials.

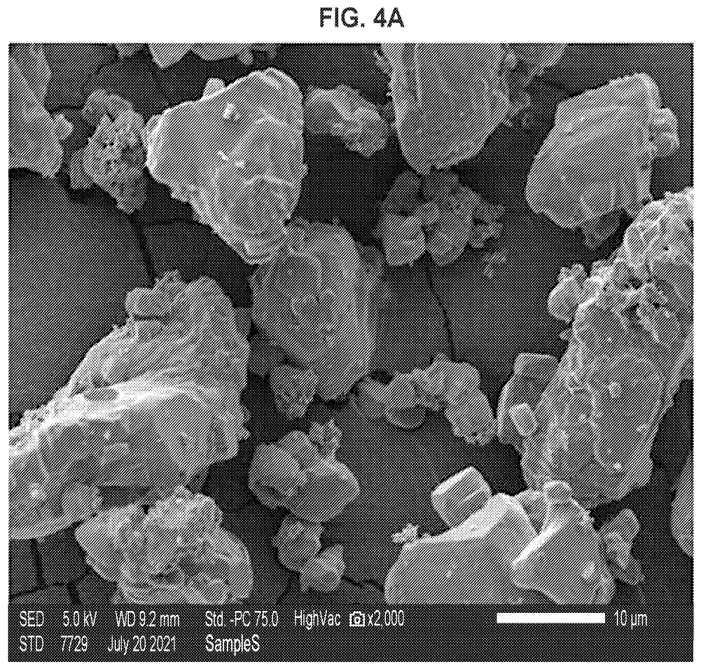

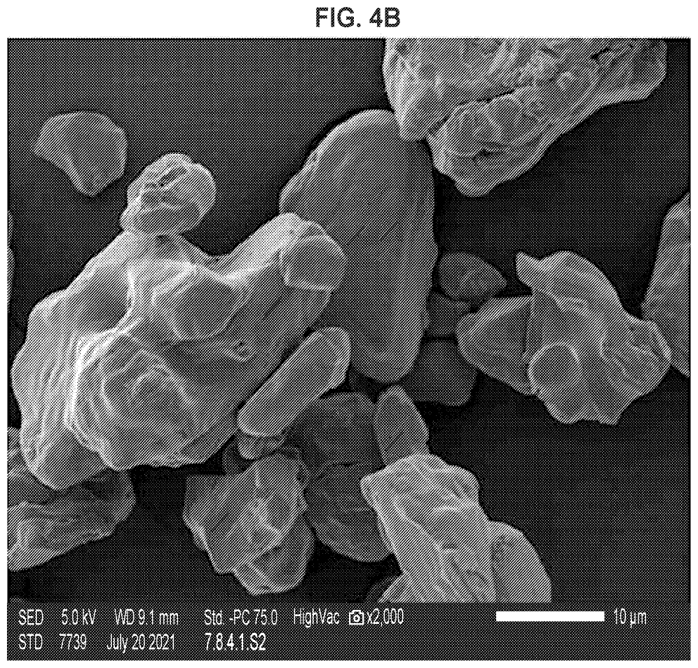

FIG. 3A shows the recovered LCO cathode material with an Al₂O₃ coating impurity. FIG. 3B shows the recovered LCO cathode material after the removal of the Al₂O₃ coating impurity. FIG. 4A shows an SEM image of regenerated LCO cathode particles, while FIG. 4B shows the regenerated LCO cathode material with Al₂O₃ coating impurities removed prior to regeneration. Both FIGS. 3B and 4B show successful removal of the fine Al₂O₃ particles from the LCO cathode materials.

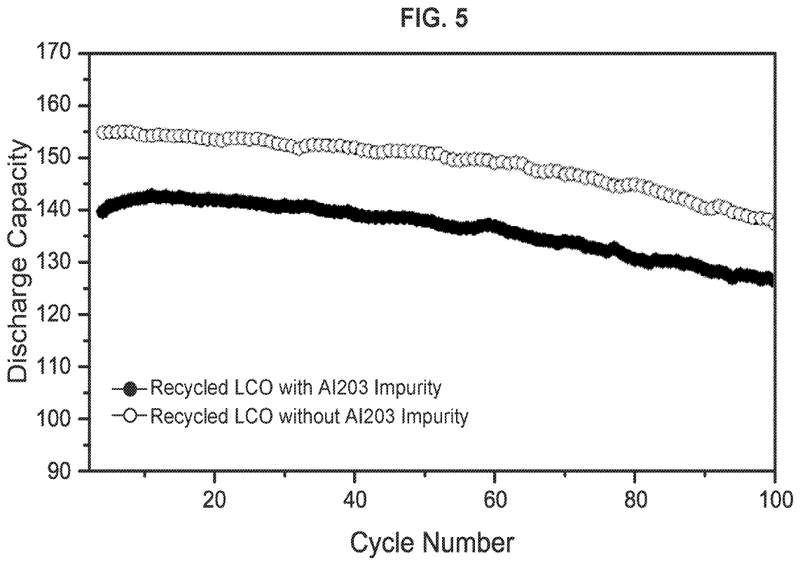

The electrochemical performance of the recycled LCO with Al₂O₃ removal is compared to the performance of LCO without Al₂O₃ removal. The electrochemical performances were measured in CR-2032 type coin cells composed of a lithium metal electrode, a polypropylene separator, an electrode made from recycled or standard materials, and an electrolyte of 1 M LiPF₆ in ethylene carbonate (EC):dimethyl carbonate (DMC) (3:7 by volume). The recycled or standard electrodes were prepared by mixing 80 wt % recycled powder with 10 wt % PVDF and 10 wt % conductive carbon. The coin cells were charged and discharged at a 1C rate. FIG. 5 shows a comparison of the discharge capacity during the 1C cycling. The recycled LCO with Al₂O₃ removed exhibited about 10-15 mAh/g higher discharge capacity than that of the recycled LCO without Al₂O₃ removal.

An additional example pertains to the addition of Li₂Si₂O₅ coating during the recycling of an NCM cathode from a used battery electrode. The cathode materials (NCM) were extracted from the used cathode electrode. An extra amount of lithium salt, including LiOH, was added and thoroughly mixed with the NCM powder. The mixture was sintered at 500-900° C. for 4-10 hours. After grinding, orthosilicic acid was then added to the sintered NCM and thoroughly mixed. The residual lithium on the surface of the NCM reacts with the orthosilicic acid and forms Li₂Si₂O₅. The NCM was then sintered again between 500° C. and 900° C. for 2-8 hours to finish the regeneration and coating operation.

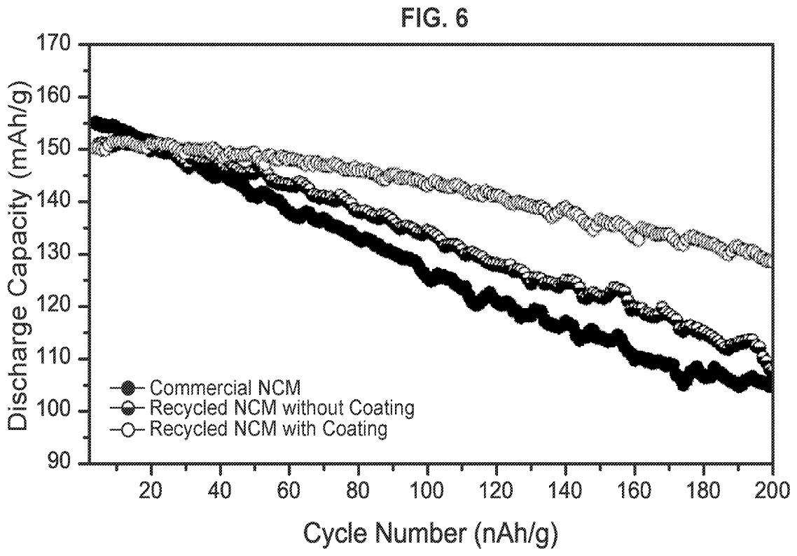

The electrochemical performance of the recycled NCM with Li₂Si₂O₅ coating was compared to that of the NCM without Li₂Si₂O₅ coating. The electrochemical performances were measured in CR-2032 type coin cells composed of a lithium metal electrode, a polypropylene separator, an electrode made from recycled or standard materials, and an electrolyte of 1 M LiPF₆ in EC/DMC (3:7 by volume). The recycled or standard electrodes were prepared by mixing 80 wt % recycled powder with 10 wt % PVDF and 10 wt % conductive carbon. The coin cells were charged and discharged at 1C. FIG. 6 shows the comparison of the discharge capacity during the 1C cycling. Comparing to the virgin standard NCM materials, the recycled NCM without Li₂Si₂O₅ coating shows slightly lower (around 5 mAh/g) initial discharge capacity but similar capacity retention after 200 cycles. The recycled NCM with Li₂Si₂O₅ coating also shows slightly lower (around 5 mAh/g) initial discharge capacity but much better capacity retention (around 25 mAh/g higher) after 200 cycles.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed descriptions. It is intended that all such additional systems, processes, and features be included within this description, be within the scope of the present invention, and be protected by the accompanying claims.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “of” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
suspending an electrode mixture in a solvent, the electrode mixture including an electrode material and a coating material;
agitating the electrode mixture via at least one of sonication or stirring, such that the coating material separates from the electrode material; and
separating the electrode material from the coating material.

2. The method of claim 1, wherein a binder holds the coating material to the electrode material, and wherein the solvent dissolves the binder.

3. The method of claim 1, wherein the electrode mixture is from a first electrode, the method further comprising:
removing a packaging from a battery; and
separating the first electrode from a second electrode and a separator.

4. The method of claim 1, further comprising:
regenerating the electrode material.

5. The method of claim 4, wherein the regenerating includes a heat treatment operation.

6. The method of claim 4, wherein the regenerating includes a relithiation process.

7. The method of claim 1, wherein the coating material is a first coating material, the method further comprising:
coating the electrode material with a second coating material.

8. The method of claim 7, wherein the coating is via at least one of mechanical fusion, sol-gel coating, co-precipitation, heat treatment, chemical vapor deposition, organic pyrolysis, chemical plating, physical vapor deposition, plasma-enhanced chemical vapor deposition, or electrochemical plating.

9. The method of claim 7, wherein the coating includes at least one of an oxide, a nitride, a carbonate, a sulfate, a fluoride, or a carbon-based material.

10. The method of claim 1, further comprising:
doping the electrode material to compensate for structural defects and compositional losses in the electrode material.

11. The method of claim 10, wherein the doping is via at least one of a solid-state reaction, a chemical reaction, a sol-gel doping operation, a co-suspension operation, a heat treatment method, or a hydrothermal method.

12. The method of claim 10, wherein the doping is via a dopant, the dopant including at least one of a nonmetal, a metal, a rare-earth metal, an actinide dopant, a carbonate, an acetate, a nitrate, a sulfate, a hydroxide, an oxide.

13. The method of claim 12, wherein the doping is via addition of a doping precursor to the electrode material, the method further comprising:
heat treating the doping precursor to form the dopant.

14. The method of claim 1, wherein separating the electrode material from the coating material includes separating based on a density difference between the electrode material and the coating material.

15. The method of claim 1, further comprising:
characterizing the coating via a characterization method, the characterization method including an optical characterization method.

16. A method, comprising:
isolating a spent electrode material;
regenerating the spent electrode material;
doping and/or coating the electrode material to improve the structural properties and electrochemical performance of the spent electrode material; and
heat treating the spent electrode material to form a restored electrode material.

17. The method of claim 16, further comprising:
forming a restored electrode from the restored electrode material; and
combining the restored electrode with a separator and an additional electrode to form a battery.

18. The method of claim 16, wherein the regenerating includes a relithiation process.

19. The method of claim 18, wherein the relithiating is via solid-state synthesis performed at least partially concurrently with the heat treating.

20. The method of claim 16, wherein the doping is via a solid-state reaction.

21. The method of claim 16, wherein the spent electrode material includes an NCM cathode.

22. The method of claim 21, wherein the doping includes addition of a Li₂Si₂O₅ coating.

23. The method of claim 22, further comprising:
adding a lithium salt to the NCM cathode.

24. The method of claim 23, wherein the heat treating includes sintering at a temperature of about 500° C. to about 900° C. for about 4 hours to about 10 hours.

25. The method of claim 24, wherein the heat treating is a first heat treatment, the method further comprising:
adding orthosilicic acid to the restored electrode material; and
heat treating the restored electrode material a second time at a temperature of about 500° C. to about 900° C.

26. A method, comprising:
mixing a spent electrode material with a solvent to form a suspension, the electrode material including a coating;
agitating the suspension to separate the coating from the spent electrode material;
separating the spent electrode material from the coating;
applying a replacement coating to the spent electrode material; and
heat treating the spent electrode material to form a regenerated electrode material.

27. The method of claim 26, wherein a binder holds the coating material to the electrode material, and wherein the solvent dissolves the binder.

28. The method of claim 26, wherein the coating includes at least one of an oxide, a nitride, a carbonate, a sulfate, a fluoride, or a carbon-based material.
